(19) United States
(12) Patent Application Publication
(10) Pub. No.: US 2009/0030726 A1
(43) Pub. Date: Jan. 29, 2009

(54) Method for Clinical Analyses of the Comparative Type

(76) Inventor: Riccardo Ortolani, Verona (IT)

Correspondence Address: Modiano & Associati, Via Meravigli, 16, Milano, 20123, IT

(21) Appl. No.: 11/887,735

(22) PCT Filed: Apr. 12, 2006
(86) PCT No.: PCT/EP2006/003384

§ 371 Date: Oct. 3, 2007

(30) Foreign Application Priority Data
Apr. 14, 2005 (IT) VR2005A000045

(51) Int. Cl. G06F 19/00

(52) U.S. Cl. 705/3

(57) ABSTRACT

A method for clinical analyses of the comparative type, comprising the following steps:
creating a reference data bank, which comprises a plurality of records, each of which is associated with a respective patient, each record having at least one comparison field containing at least one typical datum of the patient and at least one value field containing at least one laboratory datum determined by a clinical analysis on the patient;
selecting from the reference data bank a preset number of records which form a comparison set so that they have a preset typical datum which has a value substantially close or equal to the corresponding value of a patient;
determining, on the basis of the values of the laboratory data of the records of the comparison set, the respective reference value for the laboratory datum to be assessed in the patient.

The present invention relates to a method for clinical analyses of the comparative type and in particular to a method for analyzing populations and subpopulations of peripheral blood lymphocytes.

### BACKGROUND OF THE INVENTION

Clinical analyses, such as blood tests, are currently performed for various reasons, since they allow to obtain a vast amount of information regarding the values of parameters which are (or can be) linked to the health condition of the patient and are (or can be) correlated to the presence or absence of disorders in the individual on whom such clinical analyses are performed.

However, there are some problems related especially to determining the comparison values (or so-called reference values) of the populations or subpopulations of lymphocytes in peripheral blood.

The reference parameters typically used are in fact the average ones related to blood donors, and therefore do not take into account the fact that such parameters (and in particular some of them) vary significantly as a function of age, after infections (in particular HIV, CMV, EBV), and to a lesser extent according to the sex and ethnic group of the patient. Many other factors that can modify them are the subject of study.

Moreover, in order to have a more detailed picture of the clinical situation of the patient and in particular of his/her immunological condition, it is convenient to analyze a certain number of parameters, and it is then difficult, particularly for the nonspecialist physician, to be able to extract from the list of monitored parameters an overall picture of the immunological condition, and it is even more complicated to be able to compare the variation of the analyzed and monitored data over time. Finally, an overall assessment that takes into account the number of “significantly altered” parameters and especially the extent of their alteration is particularly difficult.

### SUMMARY OF THE INVENTION

The aim of the present invention is to eliminate or at least reduce drastically the drawbacks noted above by providing a new method for clinical analyses of the comparative type.

Within this aim, an object of the present invention is to provide a method for clinical analyses of the comparative type which allows to compare rapidly and effectively the values to be examined with reference values determined precisely and reliably.

Another object of the present invention is to develop a method for clinical analyses of the comparative type which can be associated with a representation of the examined values and of the reference values which allows an immediate general clinical assessment of the immunological condition of the patient.

This aim and these and other objects, which will become better apparent hereinafter, are achieved by a method for clinical analyses of the comparative type according to appended claim 1.

### BRIEF DESCRIPTION OF THE DRAWINGS

Further characteristics and advantages of the invention will become better apparent from the description of some preferred but not exclusive embodiments of a method for clinical analyses of the comparative type, which are illustrated by way of non-limiting example in the accompanying drawings, wherein:

FIG. 1 is a schematic view of a reference data bank, from which records are selected in order to define a comparison set;

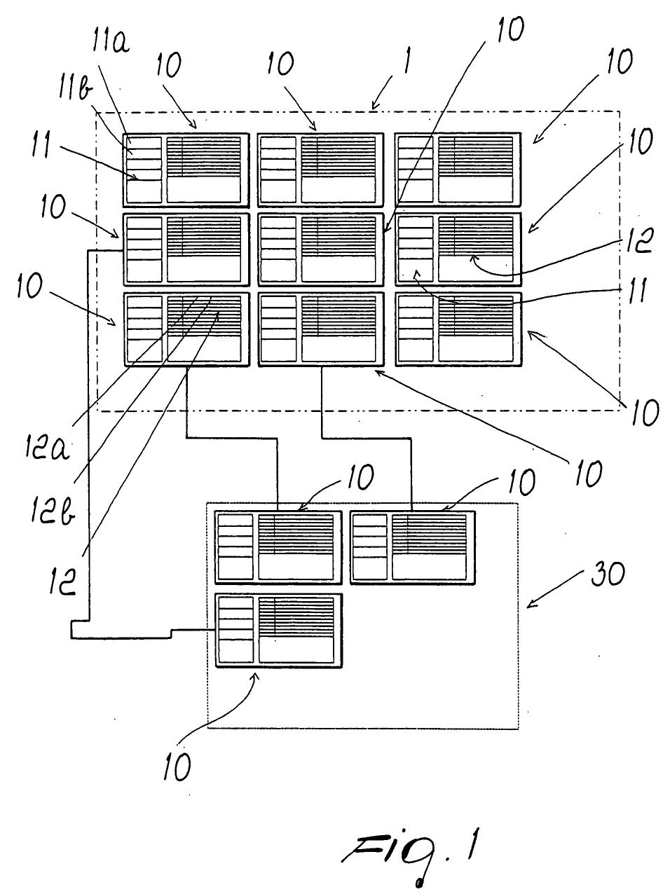

FIG. 2 is a view of an example of record, indicating typical data and laboratory data;

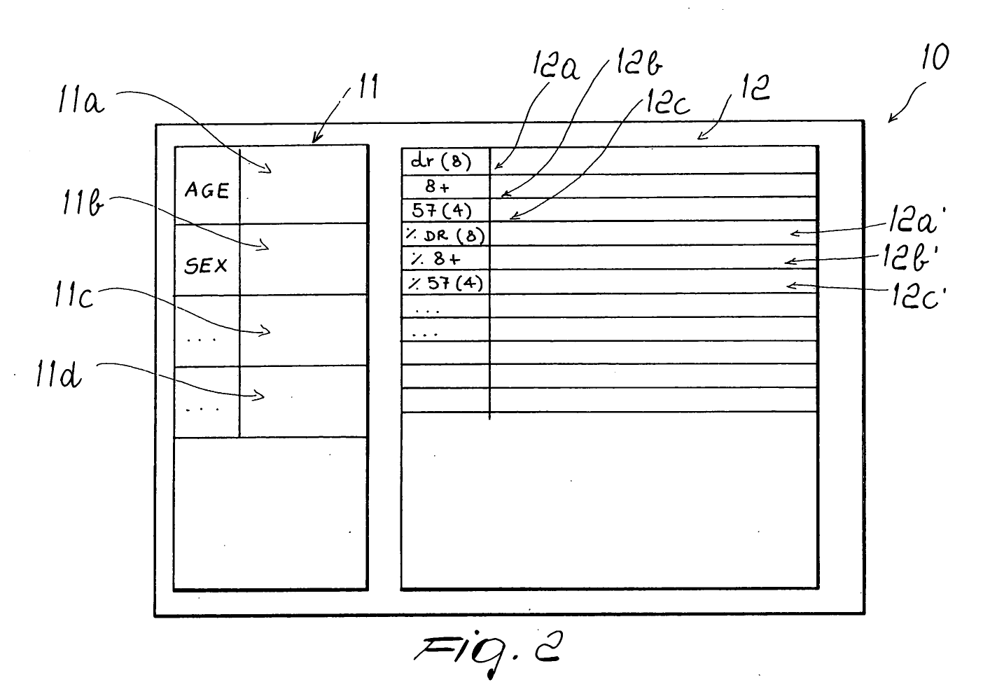

FIG. 3 is a view of an example of generic representation of the laboratory data obtained by way of a method according to the present invention;

FIG. 4 is a representation, similar to that of FIG. 3, but with the indication of some laboratory data by way of example;

FIG. 5 is a view of a possible form of representation, similar to that of FIG. 3, of the laboratory data of a patient on whom clinical analyses have been performed with a certain time interval between them;

FIG. 6 is a representation which is similar to that of FIG. 4 but indicates, by way of example, some laboratory data of a patient on whom clinical analyses have been performed with a certain time interval between them.

### DESCRIPTION OF THE PREFERRED EMBODIMENTS

In the examples of embodiments that follow, individual characteristics, given in relation to specific examples, may actually be interchanged with other different characteristics that exist in other examples of embodiments.

Moreover, it is noted that anything found to be already known during the patenting process is understood not to be claimed and to be the subject of a disclaimer.

The present invention relates to a method for clinical analyses of the comparative type and in particular relates to a method adapted for analyses of populations and subpopulations of peripheral blood lymphocytes.

In detail, the method for clinical analyses according to the invention comprises a first step, which consists in creating a reference data bank 1, which contains a plurality of records 10.

Each one of the records 10 is associated with a respective patient, and in particular contains information related to typical data and laboratory data of a patient on whom clinical analyses, typically blood tests, have already been performed.

In greater detail, each of the records 10 entered in the reference data bank 1 has at least one comparison field 11, which contains at least one typical datum (11a, 11b, 11c, et cetera) of the analyzed patient, and at least one value field 12, which contains at least one laboratory datum (12a, 12b, 12c, et cetera) determined on the basis of a previous clinical and/or immunological analysis (typically a blood test) of the analyzed patient.

Merely by way of non-limiting example, the typical data can be constituted first of all by the age of the patient (11a) when the clinical analyses are performed, but other typical data which are (or can be) entered in the comparison field 11 can be the sex of the patient (11b: male or female), the presence or absence of current or previous disorders and/or infections (11c: hepatitis, AIDS, et cetera), or the ethnic group of the patient.

After creating a sufficiently numerous reference data bank 1, so as to store therein records 10 associated with analyzed patients with high variability especially from the point of view of the various typical data 11, and in particular as regards age 11a, when it is necessary to perform clinical analyses on a patient to be analyzed, a preset number of records 10 is selected from said reference data bank 1 so as to obtain a comparison set 30.

In particular, the records 10 meant to constitute the comparison set 30 are selected, from within the reference data bank 1, so that they have at least one preset typical datum (11a, 11b, et cetera), for example the typical datum 11a related to age, which acts as a primary key, whose value is substantially close (in an extreme case, identical) to the corresponding typical datum 11a of the patient on whom the clinical analyses are to be performed.

For example, there is nothing to prevent the selection, among the records 10 that constitute the reference data bank 1, of the records 10 in which the typical datum (for example 11a related to the age of the patient) is as close as possible to the age of the patient on whom the analyses are to be performed.

Finally, the reference value and the normal deviation of the laboratory datum or data to be analyzed 12 are determined (by using for this purpose ordinary per se known statistical analysis methods) from the analysis of the values of the laboratory data (12a, 12b, 12c, et cetera) of the various records 10 included in the comparison set 30.

Advantageously, it is possible to provide that the preset number of records 10 that define the comparison set 30 be selected so that in half of said preset number of records 10 the preset typical datum 11 is greater than, or equal to, the respective typical datum of the patient on whom the clinical analyses are to be performed while, accordingly, in the remaining half of the preset number of records 10 (included in the comparison set 30) the preset typical datum 11 is smaller than, or equal to, the respective typical datum of the patient on whom the clinical analyses are to be performed.

In this manner, it is evident that the preset typical datum 11 of the patient on whom clinical analyses are to be performed lies at the 50^{th} percentile of the typical datum 11 used as primary key.

For assessment (and subsequent representation of the laboratory data), it can be convenient to determine, on the basis of the values of the laboratory data (12a, 12c, et cetera) of the records 10 included in the comparison set 30, the percentile value of the laboratory datum (or data) related to the patient on whom the clinical analyses are being performed.

This determination of the percentile value of the laboratory data (12a, 12b, 12c, et cetera) is performed in practice by comparing the value of the laboratory datum or data of the patient on whom the clinical analyses are being performed with the values of the respective laboratory data (12a, 12b, 12c, et cetera) of the records 10 that define the comparison set 30.

Of course, it is in any case possible to determine, and therefore represent, for each laboratory datum 12 to be analyzed, the values as well (both absolute and percentile): the graphical representation, in this case, includes the indication of the value of the laboratory data 12 (and of the corresponding range of the reference values calculated on the basis of the values of the laboratory data contained in the records 10 that constitute the comparison set 30) and of the percentile value of said laboratory datum.

It is further evident that it is possible to represent (again as percentiles) both the values, which can be termed absolute, of the monitored laboratory data and the so-called percentile values (12a′, 12b′, 12c′).

Depending on the type of clinical analyses to be performed, it is quite possible to use a different typical datum 11 with respect to age (11a) as primary key for selection of the records 10 that constitute the work set 30, within the reference data bank 1. For example if the patient who is to undergo the clinical analyses has a particular disorder or infection (for example AIDS), it is in fact possible to select the records 10 to be included in the comparison set 30 so that said typical datum (11c) is identical therein, or to choose two work sets: one by selecting the records 10 according to age and one according to the disorder: in this manner, it is possible to create comparison sets 30 which allow to have as comparison a series of reference data that refer to people who do not have the same disorder or infection (typical reference data) and also a series of reference data related to individuals who have the same disorder or infection (typical data of individuals with similar disorders).

Moreover, it is evident that it is straightforward to select the records 10 to be included in the work set 30 by also using secondary or tertiary keys, such as sex or the presence of particular disorders or infections (either current or previous). In this case, the records 10 to be included in the comparison set 30 must match all the keys and therefore, for example, approximate as closely as possible the age of the patient on whom the clinical analyses are to be performed, match the sex of said patient, et cetera.

Moreover, nothing prevents an appropriate balancing of the records 10 to be included in the comparison set 30 by using completely (or partially) negative keys, avoiding for example the inclusion in the comparison set of records 10 that have, within their value range 12, one or more laboratory data which differ excessively from the average values of the respective laboratory data.

The same goal can of course be achieved by avoiding, when the reference data bank 1 is created, the inclusion within said data bank of the records 10 (which, as is evident, correspond to clinical and/or immunological tests that have already been performed) which have, within the range of values 12, one or more laboratory data values that are evidently outside the reference values, due for example to particular disorders or infections.

According to an extremely important and innovative aspect of the present invention, the method for analyses of the comparative type allows to associate the values related to the typical data (11a, 11b, 11c) and to the laboratory data (12a, 12b, 12c) related to the clinical and/or immunological analyses performed (and compared with the laboratory data selected within the comparison set 30) with a new record 10, which can be entered in the reference data bank 1: it is evident that in this manner the reference data bank 1 continues to expand, rapidly reaching a size which ensures high reliability in the selection of the records 10 to be included within the comparison set 30.

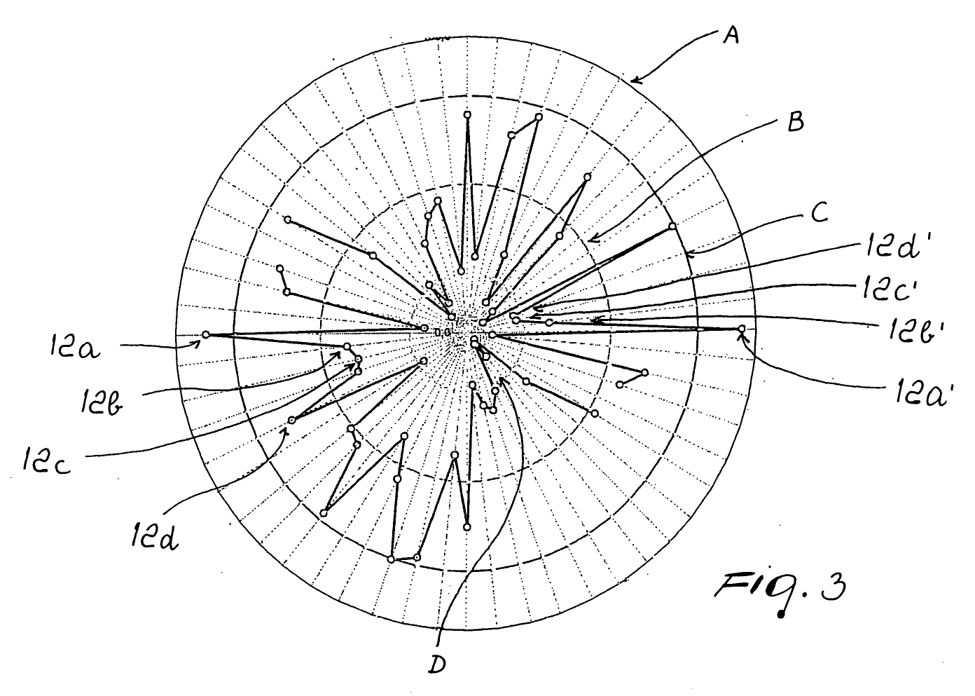

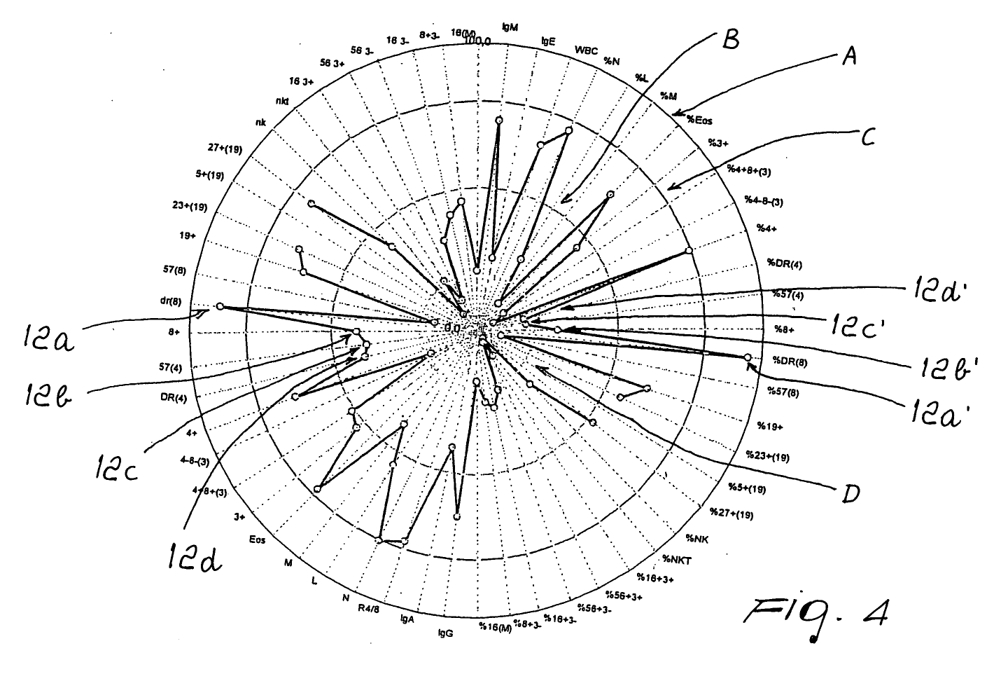

With particular reference now to FIGS. 3 and 4, it is to be noted that the method for analyses of the comparative type according to the invention optionally comprises a step for representing the laboratory data (12a, 12b, 12c).

This representation step, for example, can be performed by entering the percentile values related to each laboratory datum (12a, 12b, 12c) on a circular band on which a radially arranged percentile scale is formed.

In practice, the outermost circle (designated by the reference letter A) represents the 100^{th} percentile, the circle designated by the reference letter B represents the 50^{th} percentile, and the two intermediate circles (C and D) represent the limits of the reference range, which might be for example the 80^{th} and 20^{th} percentiles respectively.

It is evident that it is straightforward to assess how much the laboratory data (12a, 12b, 12c, 12a′, 12b′, 12c′, et cetera) differ from the 50^{th} percentile and whether they lie outside the reference range.

It is also possible to determine a deviation datum (score), which takes into account the number of data that lie, for example, outside the reference range, or an overall comparison datum related to the variations from the mean; in this case, this datum can be calculated by adding the individual variations of the mean of all or of a limited number of laboratory data.

Moreover, this representation allows to have an overall picture which allows to correlate immediately information which can be obtained by observing various laboratory data.

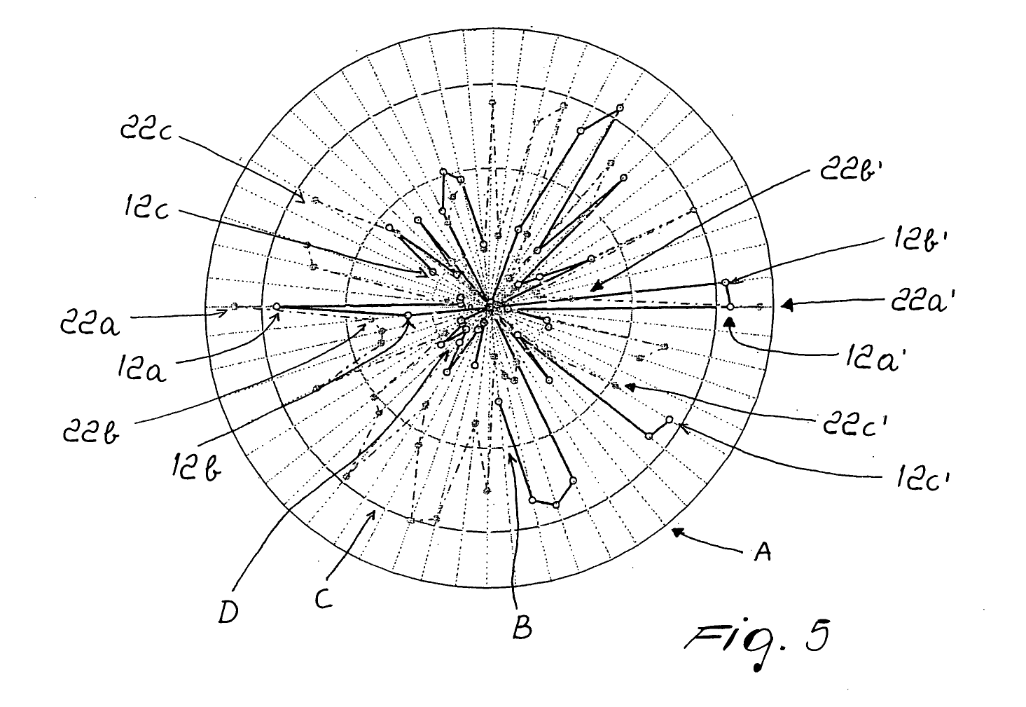

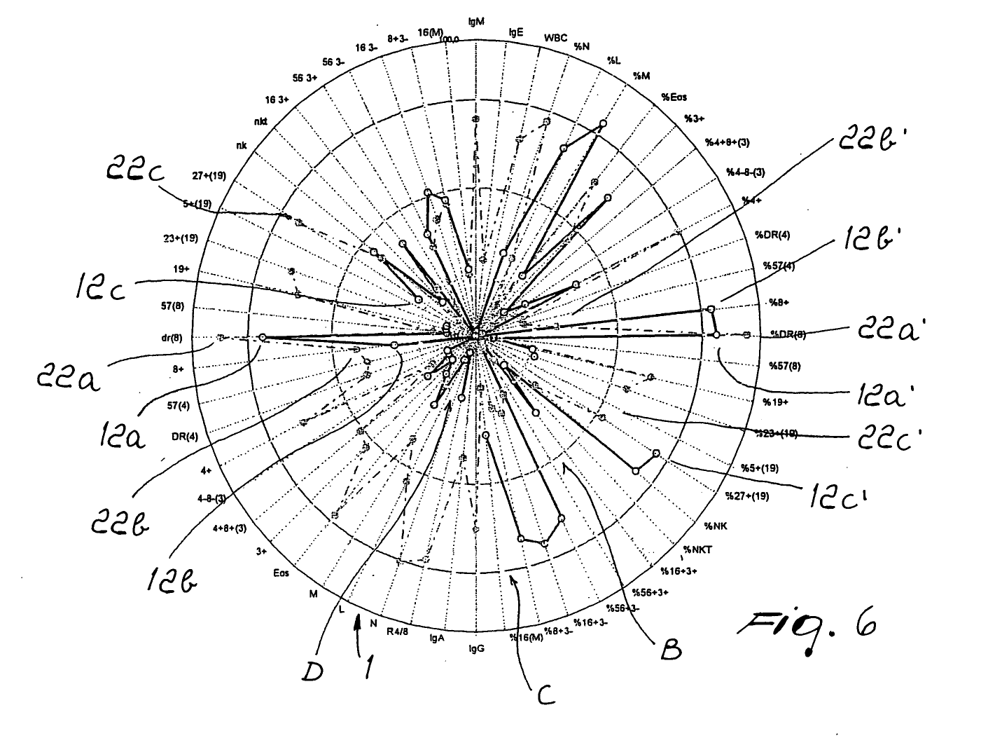

Moreover, as can be seen from the analysis of FIGS. 5 and 6, it is very convenient to check the trend of the laboratory data being monitored over time. It is in fact possible to represent on the same chart the laboratory data related to the same patient as determined by clinical analyses performed with a certain time interval between them; in particular, the reference numerals 12a, 12b, 12c, 12a′, 12b′, 12c′ designate the laboratory data (as percentiles and calculated on the basis of a first comparison set 30) acquired at a certain date, and the reference numerals 22a, 22b, 22c, 22a′, 22b′, 22c′ designate the laboratory data (these, too, as percentiles, even if they are calculated on the basis of a different comparison set if, in the meantime, the preset typical datum has changed) acquired at a later date.

It is further possible, after calculating the scores (deviation datum and overall datum) of two successive clinical analyses of the same patient, as explained above, to compare the scores and quantify the difference over the time period that has elapsed between the two clinical analyses.

All the characteristics of the invention referenced above as advantageous, convenient or the like may also be omitted or be replaced with equivalents.

The method thus conceived is susceptible of numerous modifications and variations, all of which are within the scope of the appended claims.

All the details may further be replaced with other technically equivalent elements.

The disclosures in Italian Patent Application No. VR2005A000045 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-10. (canceled)

11. A method for clinical analyses of the comparative type, comprising the following steps:
creating a reference data bank, which comprises a plurality of records, each of which is associated with a respective analyzed patient, each one of said a plurality of records having at least one comparison field, which contains at least one typical datum of the analyzed patient and at least one value field, which contains at least one laboratory datum determined by a clinical analysis on the analyzed patient;
selecting from said reference data bank a preset number of records which form a comparison set so that they have a preset typical datum which has a value substantially close to, or equal to, the corresponding value of a patient on whom said clinical analyses are to be performed;
determining, on the basis of the values of the laboratory data of the records of said comparison set, the respective reference value for the laboratory datum to be assessed in the patient on whom said clinical analyses are to be performed.

12. The method for analyses of the comparative type according to claim 11, wherein said preset number of records that define said comparison set is selected so that in half of said preset number of records the preset typical datum is greater than, or equal to, the respective typical datum of the patient on whom said clinical analyses are to be performed, while in the remaining half of said preset number of records the preset typical datum is smaller than, or equal to, the respective typical datum of the patient on whom said clinical analyses are to be performed, so that the preset typical datum of the patient on whom said clinical analyses are to be performed lies at the 50^{th} percentile.

13. The method for analyses of the comparative type according to claim 11, wherein said preset number of records that form said comparison set is selected so that their preset typical datum has a value which is as close as possible to the value of the corresponding typical datum of the patient on whom said clinical analyses are to be performed.

14. The method for analyses of the comparative type according to claim 11, wherein said at least one typical datum comprises the age of the patient.

15. The method for analyses of the comparative type according to claim 11, wherein said at least one typical datum comprises the sex of the patient.

16. The method for analyses of the comparative type according to claim 11, wherein said at least one typical datum comprises a datum related to the presence of a current or previous disorder or infection.

17. The method for analyses of the comparative type according to claim 11, wherein said determination, on the basis of the values of the laboratory data of the records of said comparison set, of the respective reference value for said at least one laboratory datum related to the patient on whom said clinical analyses are to be performed comprises the calculation of the percentile value of said at least one laboratory datum of the patient on whom said clinical analyses are to be performed by comparing the absolute or percentage value of said at least one laboratory datum of the patient on whom said analyses are to be performed with the absolute or percentage values of the laboratory data of the records that form said comparison set.

18. The method for analyses of the comparative type according to claim 11, wherein it associates the values related to the typical data and the laboratory data related to the performed clinical analyses with a new record which can be entered in said reference data bank.

19. The method for analyses of the comparative type according to claim 11, wherein said laboratory data comprise a plurality of parameters related to the populations and subpopulations of lymphocytes in blood.

20. The method for analyses of the comparative type according to claim 11, further comprising a step for representing said laboratory data which comprises entering the percentile values related to each laboratory datum on a circular band on which a percentile scale is plotted in the radial direction.
